(19) United States
(12) Patent Application Publication
(10) Pub. No.: US 2024/0313473 A1
(43) Pub. Date: Sep. 19, 2024

(54) Plug Connector Having A Locking System

(71) Applicant: ERNI International AG, Schaffhausen (CH)

(72) Inventors: Fabian Kristmann, Ebersbach (DE); Kai-Rene Semilia, Bad Ditzenbach (DE); Alexander Seibold, Sussen (DE); Martin Weihermuller, Goppingen (DE); Dominik Jonas, Pluderhausen (DE); Uwe Hokenmaier, Waschenbeuren (DE)

(73) Assignee: ERNI International AG, Schaffhausen (CH)

(21) Appl. No.: 18/678,527

(22) Filed: May 30, 2024

Related U.S. Application Data
(63) Continuation of application No. PCT/EP2022/083672, filed on Nov. 29, 2022.

(30) Foreign Application Priority Data
Dec. 1, 2021 (DE) 10 2021 131 662.6

(51) Int. Cl. H01R 13/627; H01R 13/635

(52) U.S. Cl. CPC H01R 13/6273; H01R 13/635

(57) ABSTRACT

A plug connector includes a housing and a locking system arranged on the housing. The locking system has an actuating lever and a locking lever. The locking lever has a latching element. The actuating lever and the locking lever are connected to one another at a first end of the locking lever. The locking lever is a bending bar that creates a spring force in a direction of the housing. The locking lever extends to a second end along a plug-in direction from the housing. The actuating lever is connected to the housing by a supporting web and projects beyond the supporting web in a direction opposite the plug-in direction.

### CROSS-REFERENCE TO RELATED APPLICATIONS

This application is a continuation of PCT International Application No. PCT/EP2022/083672, filed on Nov. 29, 2022, which claims priority under 35 U.S.C. § 119 to German Patent Application No. 102021131662.6, filed on Dec. 1, 2021.

### FIELD OF THE INVENTION

The present invention relates to an electrical plug connector and, more particularly, to an electrical plug connector having a locking system.

### BACKGROUND OF THE INVENTION

Electrical plug connectors are known, often with several connections, which are plugged into a connector strip to establish an electrical connection. Locking systems are provided on the plug connectors, with which the plug connectors are fixed to the connector strip when plugged in. Such locking systems have, for example, a lever that is connected to a housing of the plug connector via a web. The lever has a latching element at one end, e.g., a latching lug, which is latched into a complementary latching element on the connector strip, e.g., a latching opening. An actuating area is usually provided at the other end of the lever. The web is arranged between the two ends of the lever. When the lever is pressed in the actuating area, it rotates about the web so that the latching element moves away from the housing. The plug connector can now be unplugged.

WO 2015/055845 A1 shows a plug connector having a locking system. The lever, which is formed here by two legs, is only connected to the housing via a web.

Such plug connectors, the locking system of which is only connected to the housing via a web, have the disadvantage that if the plug connector or the connector strip is pulled when plugged in, the tensile forces act on the web at an unfavorable angle-typically at a 90° angle to the web. This can lead to plastic deformation of the web, which remains even after the lever has been actuated. This has a negative effect on the reliability of the fixation and the plug connector can loosen unintentionally.

### SUMMARY OF THE INVENTION

A plug connector includes a housing and a locking system arranged on the housing. The locking system has an actuating lever and a locking lever. The locking lever has a latching element. The actuating lever and the locking lever are connected to one another at a first end of the locking lever. The locking lever is a bending bar that creates a spring force in a direction of the housing. The locking lever extends to a second end along a plug-in direction from the housing. The actuating lever is connected to the housing by a supporting web and projects beyond the supporting web in a direction opposite the plug-in direction.

### BRIEF DESCRIPTION OF THE DRAWINGS

Embodiments of the invention are shown in the drawings and explained in more detail in the following description.

FIG. 1a shows a front view of a plug connector having a locking system according to an embodiment;

FIG. 1b shows a front view of a plug connector having a locking system according to another embodiment;

FIG. 2a is a front view of a part of the plug connector having the locking system of FIG. 1a;

FIG. 2b is a front view of a part of the plug connector having the locking system of FIG. 1b;

FIG. 3a is an isometric view of a part of the plug connector having the locking system of FIG. 1a;

FIG. 3b is an isometric view of a part of the plug connector having the locking system of FIG. 1b;

FIG. 4a is a front view of a part of the plug connector having the locking system of FIG. 1a when plugged in; and

FIG. 4b is a front view of a part of the plug connector having the locking system of FIG. 1b when plugged in.

### DETAILED DESCRIPTION

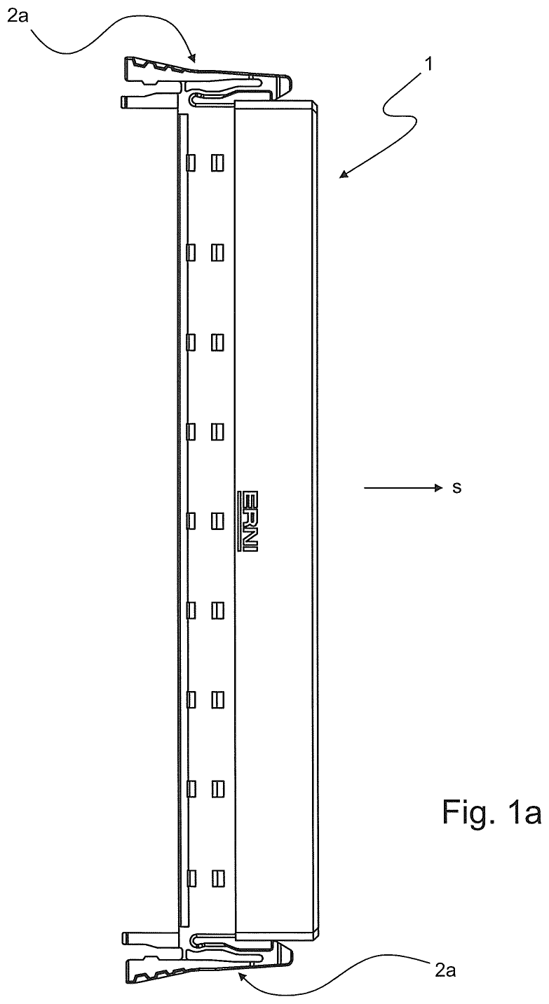

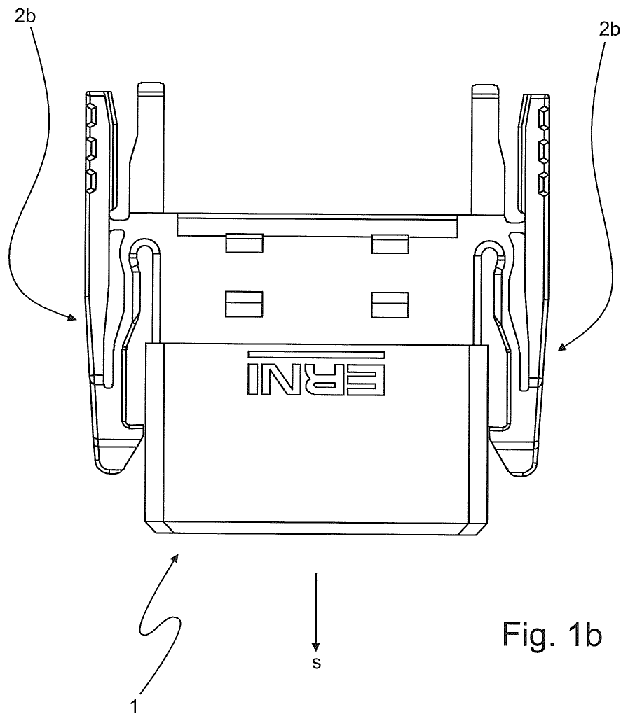

FIGS. 1a to 4b show two embodiments of a plug connector 1 according to the invention having a locking system 2a, 2b. FIGS. 1a, 2a, 3a, and 4a show a first embodiment, and FIGS. 1b, 2b, 3b, and 4b show a second embodiment.

FIG. 1a shows a wider plug connector 1, which has a first locking system 2a on both sides. In FIG. 1b, a narrow plug connector 1 is shown, which has a second locking system 2b on both sides. The first locking system 2a is optimized in such a way that it can be easily operated by a user and, in particular, can be easily actuated to open the locking system 2a. The second locking system 2b is optimized in terms of its width so that it can be used in applications with limited space. In other embodiments, the first locking system 2a can also be used with a narrower plug connector and the second locking system 2b can be used with a wider plug connector.

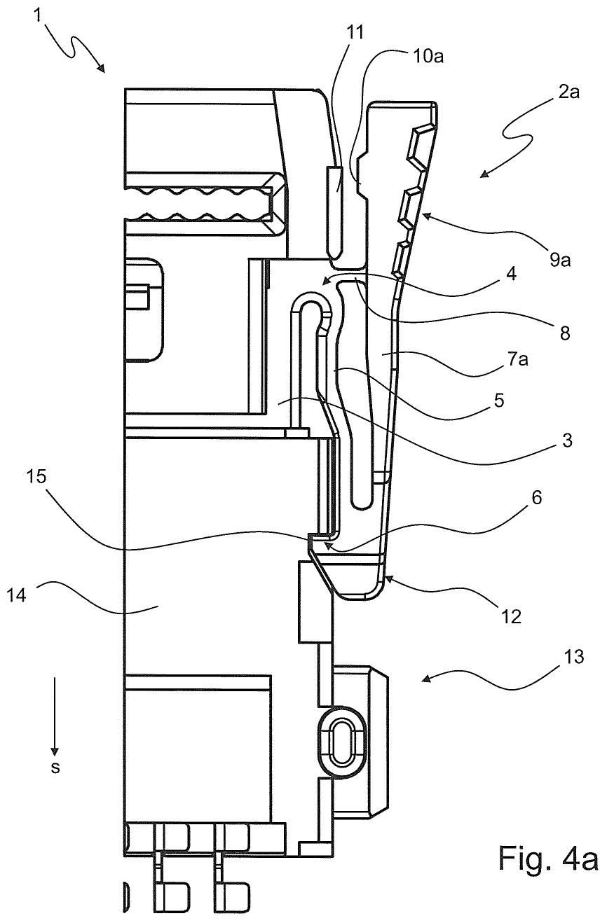

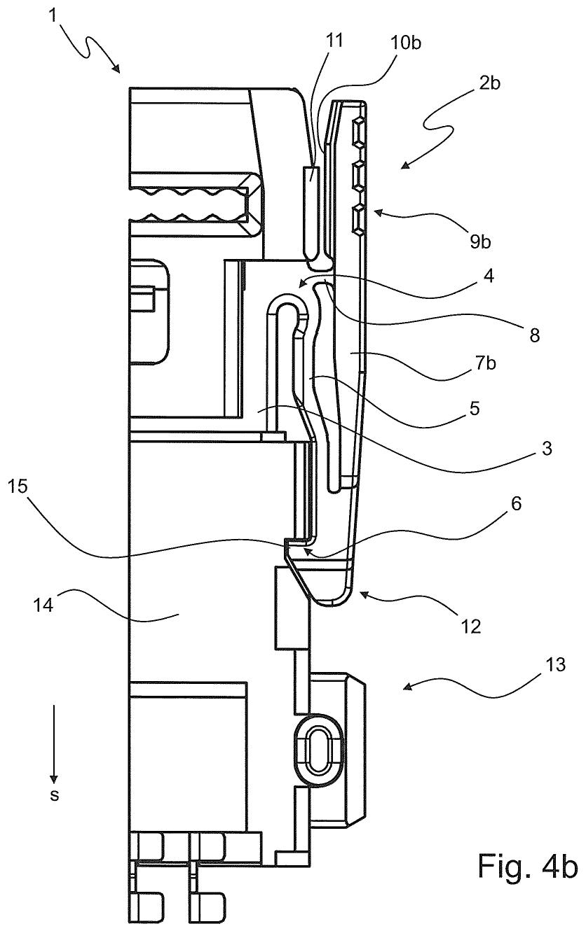

Due to the different configurations of the locking system 2a, 2b, it is possible to meet different space requirements. The plug connector 1 is plugged into a connector strip 13 for contacting. The contacting with the connector strip 13 is shown in FIGS. 4a and 4b and is described below.

In FIGS. 1a to 4b, an arrow indicates a plug-in direction S of the plug connector 1. The following description is based on the first embodiment and based on this, the differences in the second embodiment are explained.

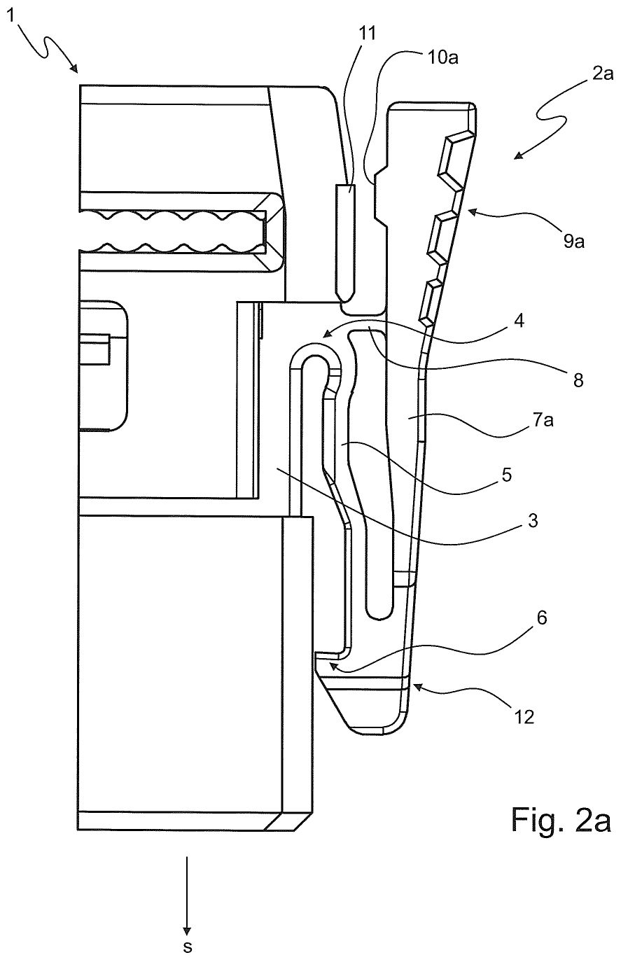

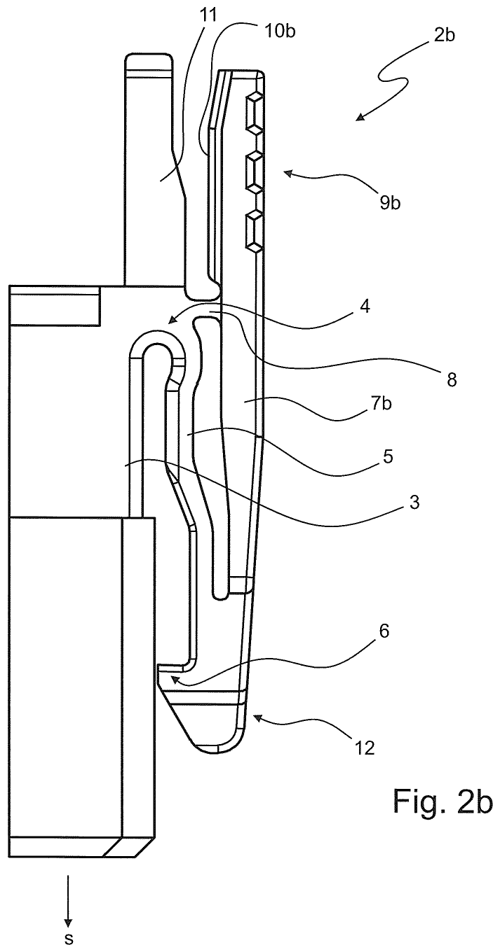

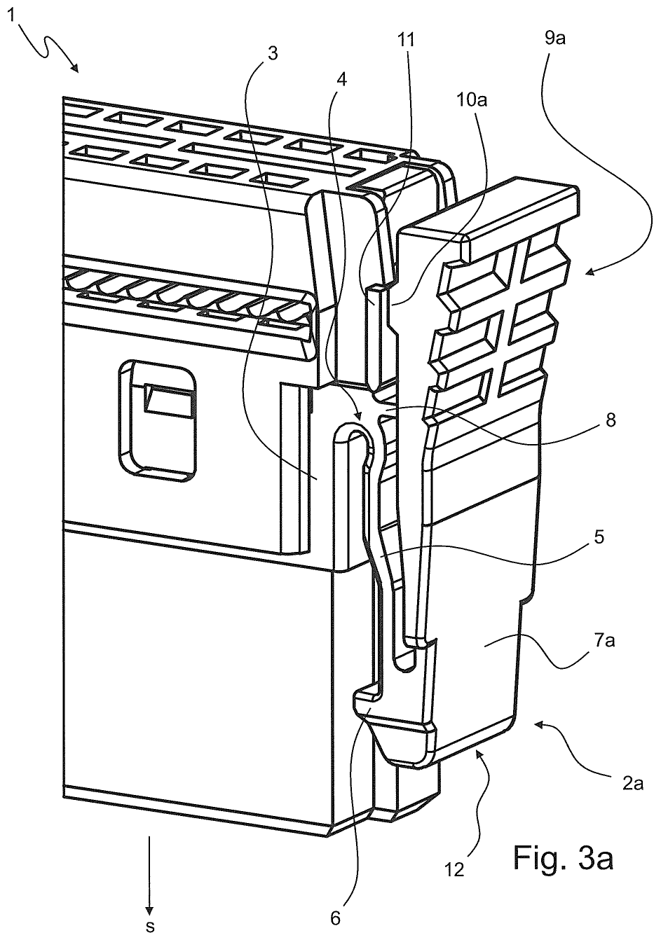

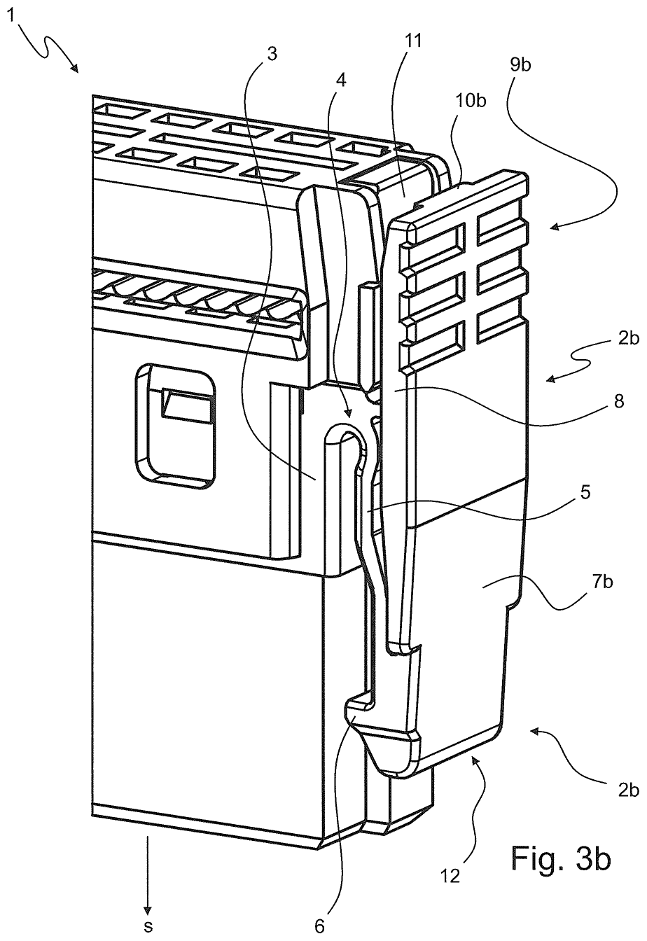

FIGS. 2a and 3a show the first locking system 2a and a section of the plug connector 1, on the housing 3 of which the first locking system 2a is arranged, in a front view (FIG. 2a) and in an isometric view (FIG. 3a). The housing 3 of the plug connector 1 has an outwardly widened area 4, which widens the housing 3 in steps perpendicular to the plug-in direction S. A locking lever 5 extends from this widened area 4 of the housing 3 along the plug-in direction S, thus forming a continuation of the widened area 4 of the housing 3 in the plug-in direction S. This provides a connection of the first locking system 2a to the housing 3 of the plug connector 1.

In general, the outwardly widened area 4 of the housing 3 can be positioned as desired, in an embodiment being as far offset to the rear as possible against the plug-in direction S, so that the locking lever 5, which is configured as a bending bar, has the greatest possible length, along which it can bring about the spring effect in the direction of the housing 3.

As shown in FIGS. 2a and 3a, a latching lug 6 is formed at the end of the locking lever 5 which is opposite the widened area 4 of the housing. The latching lug 6 is formed with an undercut, wherein a chamfer is formed in the plug-in direction S, and projects from the locking lever 5 in the direction of the housing 3 perpendicular to the plug-in direction S. Against the plug-in direction S, the latching lug 6 has a surface perpendicular to the housing 3 and the locking lever 5. The locking lever 5 is configured as a bending bar, which brings about a spring force perpendicular to the plug-in direction S in the direction of the housing 3, which is sufficient to hold the latching lug 6 securely even when plugged in.

In different embodiments, various types of latching elements can be provided, which can basically be arranged anywhere on the locking lever 5. However, the latching lug 6 has become established as the latching element for plug connectors 1 of such a type. This provides high retention forces during fixing. Thus, the locking lever 5, which is configured as a bending bar, has the greatest possible length along which it can bring about the spring effect in the direction of the housing 3. The latching lug 6 has the longest possible lead-in chamfer in the plug-in direction S to prevent the locking system 2a from standing up on a collar of the connector strip housing.

The locking lever 5 is connected at the end opposite the widened area 4 of the housing 3 to an actuating lever 7a of the first locking system 2a, as shown in FIGS. 2a and 3a. In addition, the actuating lever 7a is also connected to the widened area 4 of the housing 3 via a supporting web 8, which is formed perpendicular to the plug-in direction S, and thus forms a second connection of the first locking system 2a to the housing 3. The actuating lever 7a has an actuating area 9a against the plug-in direction S. A structured actuating surface is configured on the actuating area 9a towards the outside, with which a user can open the locking system 2a by pressing it by hand. In the first locking system 2a, the actuating area 9a is widened outwards so that the user can grip and press it more easily. Due to the protruding actuating surface, better operability is thus achieved.

When pressure is applied to the actuating area 9a of the actuating lever 7a, the actuating lever 7a rotates around the supporting web 8, which acts as a pivot point or hinge, so that the end at which the actuating lever 7a and the locking lever 5 are connected to one another and at which the latching lug 6 is arranged is moved outwards, away from the housing 3. The plug connector 2a can now be disconnected from the connector strip or plugged into it. The supporting web 8 is arranged so that it extends perpendicular to the plug-in direction S of the plug connector 1 from the housing 3; as a result, the supporting web 8 optimally absorbs the forces as a pivot or hinge when the actuating lever 7a is actuated.

A bulge 10a on the inside of the actuating lever 7a in the actuating area 9a and a complementary structure 11 on the housing 3 together form a travel limiter that limits the deflection of the actuating lever 7a and thus prevents overexpansion. In this embodiment, the bulge 10a is formed over the entire width of the actuating lever 7a. The travel limiter prevents the actuating lever 7a from being pressed too far in the direction of the housing 3 during actuation, which would lead to irreparable deformation. The travel limiter can be configured as a structure, in particular as the bulge 10a or protrusion, at the end of the actuating lever 7a and/or as the structure 11 on the housing 3.

Except at the points mentioned, the locking lever 5 and the actuating lever 7a are separated from one another. This creates an elastic area by which the locking lever 5, which is configured as a bending bar, returns to its original position when the user no longer presses the actuating area 9a of the actuating lever 7a. During actuation, the forces acting during the movement are distributed over the long length of the locking lever 5, which is configured as a bending bar, so that it undergoes slight expansion and elastic deformation occurs. The elastic area, which is formed by the combination of the locking lever 5 configured as a bending bar, the actuating lever 7a and the supporting web 8, is self-contained.

The combination of the locking lever 5, which is configured as a bending bar and forms a connection to the housing 3, the actuating lever 7a, which is connected to the locking lever 5, and the supporting web 8, which forms a second connection to the housing 3, forms the elastic area through which the locking system 2a is ideally elastic and moves back to its original position after actuation. To open the locking system 2a, it is sufficient to press the actuating area 9a by hand without the need for tools. If the actuating area 9a is no longer pressed, the locking system 2a returns to its original position and locks with the connector strip 13 when plugged in. In this way, particularly simple locking is achieved.

FIGS. 4a and 4b show the plug connector 1 in the latched state, in an assembly in which the plug connector 1 is plugged into a connector strip 13. In a housing 14 of the connector strip 13, a latching pocket 15 is formed on both sides (only one side is shown here). The latching lug 6 of the first locking system 2a and the latching pocket 15 are adapted to one another and have a complementary shape. The chamfer of the latching lug 6 formed by the undercut is configured in the plug-in direction S and facilitates insertion. The chamfer is of such a length that the locking system 2a does not rest on a collar of the housing 14 of the connector strip 13. Against the plug-in direction S, the latching lug 6 has a surface extending perpendicular to the plug-in direction S, which engages in a surface of the latching pocket 15 also extending perpendicular to the plug-in direction S, which provides a high holding force against a pull against the plug-in direction S. The locking system 2a also has a reinforcement 12 on the outside, that is, on the actuating lever 7a, and on the end at which the actuating lever 7a is connected to the locking lever 5. The reinforcement 12 contributes to increasing the overall rigidity of the latching lug 6.

As shown in FIGS. 4a and 4b, the actuating lever 7a is bent outwards starting from the widened area 4 of the housing 3 and has two kinks. As a result, the actuating lever 7a is adapted to the contour of the housing 14 of the connector strip 13 when plugged in. In addition, the width of the widened area 4 of the housing 3 of the plug connector 1 can be selected to be smaller than or at least equal to the width of the housing 14 of the connector strip 13.

If tensile forces now act on the plug connector 1 against the plug-in direction S and/or in the plug-in direction S on the connector strip 13 when plugged in, these tensile forces are absorbed directly by the widened area 4 of the housing 3 via the locking lever 5. Only torsional forces and no bending forces occur in the entire locking system 2a.

In addition, when the actuating lever 7b is actuated, the movement is distributed over the long length of the bending bar so that it undergoes less expansion and an elastic deformation occurs, which is reversible. Tensile forces against the plug-in direction S are thus dissipated directly into the housing 3 via the bending bar, while the actuating forces act on the supporting web 8. In this way, the tensile forces against the plug-in direction S are decoupled from the actuating forces. The result is a secure fixing of the plug connector 1.

The second locking system 2b, shown in FIGS. 1b, 2b, 3b, and 4b, differs from the first locking system 2a in that the actuating lever 7b does not widen in the actuating area 9b, but runs straight. In addition, the distance between the actuating lever 7b and the locking lever 5 or the housing 3 is smaller. This results in a more compact construction and the plug connector 1 can be used in applications with limited space. The area in which the actuating lever 7b and the locking lever 5 are connected to one another is correspondingly larger to achieve a more direct response during actuation. In the second locking system 2b, a structured actuating surface is also configured on the actuating area 9b towards the outside, with which a user can open the locking system 2b by pressing it by hand. In addition, a bulge 10b is provided on the inside of the actuating lever 7b in the area of the actuating area 9b and a complementary structure 11 on the housing 3, which together form a travel limiter that limits the deflection of the actuating lever 7a and thus prevents overexpansion. In this embodiment, the bulge 10b is formed centrally in the actuating lever 7b and already comes into contact with the complementary structure 11 closer to the supporting web 8. The complementary structure 11 may be configured in such a way that it can interact with both variants of bulges 10a, 10b.

The locking systems 7a, 7b described above offer a secure fixation when tension is applied to the plug connector 1 and/or the connector strip 13 and at the same time can be released in a simple manner.

What is claimed is:

1. A plug connector, comprising:
a housing; and
a locking system arranged on the housing, the locking system has an actuating lever and a locking lever, the locking lever has a latching element, the actuating lever and the locking lever are connected to one another at a first end of the locking lever, the locking lever is a bending bar that creates a spring force in a direction of the housing, the locking lever extends to a second end along a plug-in direction from the housing, the actuating lever is connected to the housing by a supporting web and projects beyond the supporting web in a direction opposite the plug-in direction.

2. The plug connector of claim 1, wherein the latching element is a latching lug arranged at the second end of the locking lever.

3. The plug connector of claim 1, wherein the supporting web is arranged on the housing at a point at which the locking lever extends from the housing.

4. The plug connector of claim 1, wherein the supporting web extends perpendicular to the plug-in direction from the housing.

5. The plug connector of claim 1, further comprising a travel limiter arranged at an end of the locking system opposite the plug-in direction.

6. The plug connector of claim 5, wherein the travel limiter is positioned at a distance from the supporting web.

7. The plug connector of claim 5, wherein the travel limiter includes a bulge on an inside of the actuating lever.

8. The plug connector of claim 5, wherein the travel limiter includes a structure on the housing.

9. The plug connector of claim 7, wherein the travel limiter includes a structure on the housing that is complementary to the bulge.

10. The plug connector of claim 1, wherein the actuating lever has an actuating area at an end opposite the plug-in direction.

11. The plug-in connector of claim 10, wherein the actuating area is widened outward.

12. The plug-in connector of claim 10, wherein the actuating area has a structured actuating surface on an outside of the actuating lever.

13. The plug-in connector of claim 1, wherein the housing has an outwardly widened area that widens the housing perpendicular to the plug-in direction.

14. The plug-in connector of claim 13, wherein the locking lever extends from the outwardly widened area.

15. The plug-in connector of claim 2, wherein the latching lug has an undercut and projects from the locking lever in a direction of the housing perpendicular to the plug-in direction.

16. The plug-in connector of claim 15, wherein the latching lug has a chamfer formed in the plug-in direction.

17. The plug-in connector of claim 13, wherein the actuating lever is bent outwards starting from the outwardly widened area.

18. An assembly, comprising:
a connector strip having a connector housing; and
a plug connector plugged into the connector strip, the plug connector including a plug housing and a locking system arranged on the plug housing, the locking system has an actuating lever and a locking lever, the locking lever has a latching element, the actuating lever and the locking lever are connected to one another at a first end of the locking lever, the locking lever is a bending bar that creates a spring force in a direction of the plug housing, the locking lever extends to a second end along a plug-in direction from the plug housing, the actuating lever is connected to the plug housing by a supporting web and projects beyond the supporting web in a direction opposite the plug-in direction.

19. The assembly of claim 18, wherein the latching element engages in a latching pocket of the connector housing.

20. The assembly of claim 18, wherein the plug housing has a width that is less than or equal to a width of the connector housing.
